(19) United States
(12) Patent Application Publication
(10) Pub. No.: US 2025/0200654 A1
(43) Pub. Date: Jun. 19, 2025

(54) AUTOMATED RECOURSE

(71) Applicant: MULTI SERVICE TECHNOLOGY SOLUTIONS, INC., Overland Park, KS (US)

(72) Inventors: Daniel Wayne ZIMMERMAN, Overland Park, KS (US); Brandon Dean BLAYLOCK, Prairie Village, KS (US); Derek Robert OVERBY, Covington, LA (US); Irfan Azeem SAYYAD, Harahan, LA (US); Madhavi Guntupalli MANNE, Alpharetta, GA (US); Larissa Ann LOVERN, Covington, LA (US); Jennifer Louise GERMAN, Camdenton, MO (US); Donald Laverne TROTT, Picayne, MS (US)

(21) Appl. No.: 18/543,915

(22) Filed: Dec. 18, 2023

(51) Int. Cl. G06Q 40/03; G06Q 30/018

(52) U.S. Cl. CPC G06Q 40/03; G06Q 30/018

(57) ABSTRACT

A computer-implemented method and system for authorizing user access to services provided by a first entity is disclosed. The method involves receiving a request to authorize a user, retrieving a plurality of user-related metrics from a database, generating a risk metric based on these metrics, and automatically determining the user's authorization based on the risk metric. The authorization decision involves a second entity assuming risk for the services provided by the first entity. The method further includes communicating the authorization decision to a graphical user interface, providing a clear indication of the user's authorized access.

### BACKGROUND

Merchant credit applications are submitted by business entities to request trade credit for business-to-business transactions. Each merchant credit application requires a large amount of data retrieval from a variety of sources. Merchant credit applications may not be from existing or well-known business entities. Approval for credit is contingent on external sources of information related to a merchant applicant.

### SUMMARY

At a high level, aspects described herein relate to systems and methods that process merchant credit applications. The present technological advance can absolve technological issues, which the merchant credit applications present based on their need for much internal and external data.

Credit application processes typically require obtaining information from various external sources, which often come in different formats, making it challenging to analyze and process. The sources for this information can change frequently, leading to additional complexities. Traditional methods for authorizing user access have been manual, time-consuming, and prone to errors. Moreover, once credit issuers make a decision, there's generally no recourse for merchants or applicants. This disclosure introduces a novel system that addresses these challenges. It centralizes the acquisition of data from multiple external sources, normalizing this data, and converting it into a single risk metric. This allows merchants to assess an applicant's creditworthiness without seeing the comprehensive data, providing a more streamlined, adaptable, and efficient solution. Furthermore, this system permits merchants a say in the approval process, offering more flexibility in decision-making based on the risk metric, even if the applicant lacks ideal creditworthiness. This is a significant departure from the current technology, emphasizing automation and recourse.

In one aspect, one or more media storing computer-readable instructions is disclosed. The computer-readable instructions are executed by one or more processors to perform one or more computer operations that comprise receiving, by a centralized integration processor, a request to authorize a user to use services provided by a first entity.

The media further instruct to retrieve, by the processor from a database, a plurality of metrics associated with the user. Additionally, the instructions generate, by the processor, a risk metric based on the plurality of metrics associated with the user. Further, the instructions automatically determine, by the processor, based on the risk metric, that the user is authorized to use the services of the first entity with a second entity assuming risk for the services provided by the first entity. Finally the processor sends an instruction to a graphical user interface that the user is authorized to use the services of the first entity.

Aspects herein provide a method for a merchant credit application. The method comprises receiving, by a processor, a request to authorize a user to use services provided by a first entity. Additionally, the method comprises retrieving, by the processor from a database, a plurality of metrics associated with the user. Subsequently generating, by the processor, a risk metric based on the plurality of metrics associated with the user. Further the method comprises, automatically determining, by the processor, based on the risk metric, that the user is authorized to use the services of the first entity with a second entity assuming risk for the services provided by the first entity. Finally, the method comprises communicating to a graphical user interface, by the processor, that the user is authorized to use the services of the first entity.

Additional aspects considered hereof provide a system comprising a processor that may perform operations to a computer-implemented method. The method comprises receiving, by a processor, a request to authorize a user to use services provided by a first entity. Additionally, the method comprises retrieving, by the processor from a database, a plurality of metrics associated with the user. Subsequently generating, by the processor, a risk metric based on the plurality of metrics associated with the user. Further the method comprises, automatically determining, by the processor, based on the risk metric, that the user is authorized to use the services of the first entity with a second entity assuming risk for the services provided by the first entity. Finally, the method comprises communicating to a graphical user interface, by the processor, that the user is authorized to use the services of the first entity.

This summary is intended to introduce a selection of concepts in a simplified form that is further described in the detailed description section of the present disclosure. It is neither intended to identify key or essential features of the claimed subject matter, nor is it intended to be an aid in determining the scope of the claimed subject matter. Additional objects, advantages, and novel features of the technology will be set forth in part in the detailed description that follows, and in part will become apparent to those skilled in the art upon examination of the present disclosure or learned through practice of the technology.

### BRIEF DESCRIPTION OF THE DRAWINGS

The present technology is described in detail below with reference to the attached drawing figures, wherein:

FIG. 1 is an example operating environment in which aspects of the present disclosure may be employed to process and authorize a merchant credit applicant;

FIG. 2 is an example computing device suitable for implementing aspects of the present disclosure, in accordance with an embodiment described herein;

FIG. 3 is an example process flow that can be performed by components of the operating environment of FIG. 1 and the computing device of FIG. 2, in accordance with an aspect described herein; and

FIG. 4 is a block diagram illustrating example operations that can be performed by the components of the operating environment of FIG. 1, in accordance with aspects described herein.

### DETAILED DESCRIPTION

Credit applications are submitted from a user to obtain credit that can be extended to that user by a credit issuer. In some cases, the applicant is a business that wishes to obtain credit to be used at a particular merchant. When the applicant provides information through the application process, the credit issuer may then use that information to obtain further information from external sources. Such information may be commercial credit information, personal credit information, uniform commercial code data, and office of foreign assets and control data. Each piece of information likely comes from a distinct external source that requires coordination of many application program interfaces and retrieval of a variety of different formatting of data. Some sources of the information may differ in a format they provide that information in, and, as such, external data must also be converted into a usable, normalized data. Additionally, the incoming data and information may be large and confusing to analyze and process.

The sources of the information desired may also change at a rapid pace. For example, the commercial credit information may come from a credit monitoring service when the merchant credit applications are first being received. In the future, the commercial credit information may come from a different credit monitoring service. Additionally, the credit issuers may, in the future, require additional or different information than currently required for a trade credit to be issued to a merchant. As such, changes occurring to a merchant credit application processing software must be entirely rewritten to accommodate the new service.

In the prior art, the process of authorizing user access to services provided by a first entity often involved manual evaluation and decision-making by human administrators. This approach was time-consuming, prone to errors, and lacked consistency. It relied heavily on subjective judgments and limited factors, which could result in both false positive and false negative authorization decisions. Additionally, the manual process was not efficient enough to handle a large volume of user authorization requests, leading to delays and increased administrative overhead. As technology advanced and the number of users and services increased, the traditional manual approach became increasingly inadequate and hindered the scalability and effectiveness of the authorization process. Furthermore, the traditional methods typically did not consider a comprehensive range of metrics associated with the user, resulting in a limited assessment of the user's risk profile. Without a holistic understanding of the user's risk factors, the authorization decisions were less accurate and failed to adapt dynamically to changing circumstances.

A technical challenge is the inefficiency in amalgamating data from various sources and platforms into one cohesive system. Clients and financial institutions often find themselves ensnared in a labyrinth of data sources, including myriad websites, direct communications, and archaic databases, to gather essential details about financing offers and credit terms. This piecemeal approach triggers significant spikes in computer input/output (I/O) activities. Specifically, there's a surge in physical read/write activities on non-volatile disks during data operations, which not only is time-intensive and error-prone but also accelerates the wear and tear of system components. Additionally, users who constantly tap into these scattered information resources face substantial computational costs. For instance, every initiated query mandates the activation of an optimizer engine within the database manager module, aiming to formulate an optimal execution strategy. This entails calculations based on multiple parameters, such as cardinality and selectivity. Continually initiating this cycle to ascertain the most efficient plan for executing queries, especially when dealing with multiple credit applications, significantly diminishes system throughput and escalates network latency. When you factor in that most database relationships contain hundreds or even thousands of entries, this repetitive computation on vast data rows further curtails system performance and heightens latency. It becomes evident that the existing approach is neither efficient nor nimble, highlighting a pressing need for a more consolidated, smart, and centralized solution in the financial landscape.

Additionally, in the current state of the art, once a credit issuer denies or approves an applicant, there is no recourse for the merchant or the applicant other than possibly an appeal. There is a need for a system that allows for the merchant to be able to approve the credit to be issued to the applicant for business purposes. For example, if an applicant is a long-standing client, the merchant may desire to extend the credit even though the applicant does not have great creditworthiness. By allowing the merchant to approve or deny the applicant, significant technological issues arise. The credit issuer must allow the merchant to view the credit worthiness of the applicant but may not wish for them to see the entirety of the external data. The current technology does not allow for this, and as such, a technological solution is provided herein.

The present disclosure provides methods of obtaining information about a credit applicant from external sources. These external sources are varied and may come in differing formats. The methods used herein convert this external data into a risk metric that incorporates the application and all externally obtained information. This allows the merchant user to conveniently analyze the risk associated with the applicant without viewing any potentially proprietary decision-making data. By converting the entire risk data into a single risk score or metric, the technological problem is solved.

Additionally, a centralized system is able to receive any non-standardized data from an external source and convert it to normalized data to be used in credit decision logic and generate a risk metric. The system retrieves external data from a wide array of sources that requires the centralized integration system to be capable of interacting with multiple interfaces and programs. As such, the current technology provides the centralized integration service that houses application program interfaces that directly communicate with each of the external sources. The service is also able to retrieve and store data in normalized standards that may not come from the external sources. This is different from current systems that do not have the centralized integration system that communicates with the external sources and retrieves information from each of the many external sources and may potentially store dissimilar data structures in original non-standardized data structure(s).

Relative to existing technologies and computer functionality, the methods of the present disclosure reduce network latency, reduce packet generation costs, and reduce computer input/output (I/O), among other computer function benefits. This embodiment streamlines the process by using a single service or server to communicate with external sources during credit application processing. This reduces the need to contact multiple hardware components over a computer network, enhancing efficiency. What this means is that fewer (or no) packets must be generated and sent over the computer network. Each time a service is contacted, for example, contents or payload of the request is typically supplemented with header information or other metadata within a packet in TCP/IP or other protocol networks. Accordingly, when this functionality is multiplied by all the services needed to obtain the desired data, there are network latency costs from repetitively generating the metadata and sending it over the computer network. However, as described above, in this technology, communication with external sources occurs using only the single service or the server, which means there are fewer packets to generate and fewer messages to traverse the computer network, thereby reducing network latency. This has a further technical effect of decreasing the computer I/O. With respect to the existing technologies, continuous communication with multiple services increases storage device I/O (for example, excess physical read/write head movements on non-volatile disk) because, with each communication or data packet sent, a computing system has to reach out to the storage device I/O to perform a read or write operation, which is error prone, and eventually wears on components, such as a read/write head. When multiplied by all the multiple service communication requirements, this causes excessive wear on the read/write head and causes excessive energy consumption and heat, which leads to other computational issues, such as memory errors. However, as described above, there are fewer (or no) times that embodiments perform I/O with the subject technology. Consequently, there is not as much wear and tear on the read/write head, and there is not as much energy consumption and heat generation, and hence the likelihood of memory errors is reduced.

The aspects delineated herein delineate a system devised to confront the prevalent issues of inefficiency and lack of centralization rampant in the current invoice financing landscape. This innovation hinges on the utilization of at least one processor and computer storage media harboring instructions. This sophisticated setup empowers the system to fetch and assemble crucial metrics pertaining to various stakeholders including lenders, sellers, buyers, and prospective credit users, cultivating a rich repository of indispensable data. This comprehensive assemblage of information is then harmoniously integrated into a database, potentially unified under a singular format or presented through a one-stop user interface page. Venturing beyond mere data compilation, the system leverages the processor to conceptualize a visualization tool that may depict varying aspects of the invoice financing ecosystem coupled with pertinent metrics, thus granting users an enriched, bird's-eye view of the operational landscape. In doing so, it significantly trims down the exhaustive time and effort historically spent sifting through disconnected data sources, thereby redefining ease of access to vital services in the invoice financing space

By consolidating such information and processes into a singular, centralized system, the innovation drastically curtails the tedious processes of extensive searches, multiple page navigations, and complex route explorations that clients in the invoice financing sector previously had to endure. This pivotal shift not only amplifies user navigation speed, ushering in a fluid and streamlined user journey but also eradicates the strenuous experiences historically associated with such operations. Furthermore, the unification of this wealth of data into a standalone database or user interface page ingeniously diminishes computer Input/Output (I/O) demands, thereby reducing the strain on computational resources. This meticulous arrangement concurrently tackles the issue of network latency, a persistent hurdle in the existing setups, facilitating a swift, responsive, and essentially smoother operational conduit, enhancing the overall user experience manifold in the invoice financing landscape. Regarding I/O, there are fewer read and writes to a storage device because all the information is consolidated into a single data store so the read/write head or other storage access component only has to reach out to a storage device a single time (or fewer times) relative to a storage access component that has to reach out to a storage device multiple times for each unit of data. Regarding network latency, there are fewer query execution plans that are generated to fetch records and thus an optimizer engine is performing less computational overhead (e.g., less selectivity calculations). There is also reduced network latency because only a single database is accessed, as opposed to several databases of disparate information (which may occur because a user traditionally has to perform multiple search queries at a browser for different sets of data). There is also reduced network latency because there are fewer communication channels opened since the data is more centralized at a single database. This means, for example, that there is less TCP/IP or other network protocol packets being sent over a network and less handshaking, thereby reducing network latency.

Additionally, in some embodiments, the methods of the present disclosure improve computer security relative to existing technologies because the external sources are contacted and accessed using the single service rather than multiple services. In other words, the more times a data packet has to traverse the computer network (which occurs with existing technologies), the higher the likelihood that data will be sniffed or otherwise compromised. Sniffing is a process of monitoring and capturing all data packets passing through a given network. Attackers use sniffer code to capture data packets containing sensitive information, such as passwords, account information, and the like. However, as described above, some embodiments only use the single service rather than multiple services, which means there are less packets getting transmitted over the computer network, which consequently means that the data is less likely to be sniffed by attackers. The centralized integration service is also easily modifiable to adapt to changing external source code or systems since the centralized integration service is built based on the volatility-based decomposition architecture that allows for only a portion of the architecture to be changed at a time.

It will be realized that the method previously described is only an example that can be practiced from the description that follows, and it is provided to understand the technology and recognize its benefits. Additional examples are now described with reference to the figures.

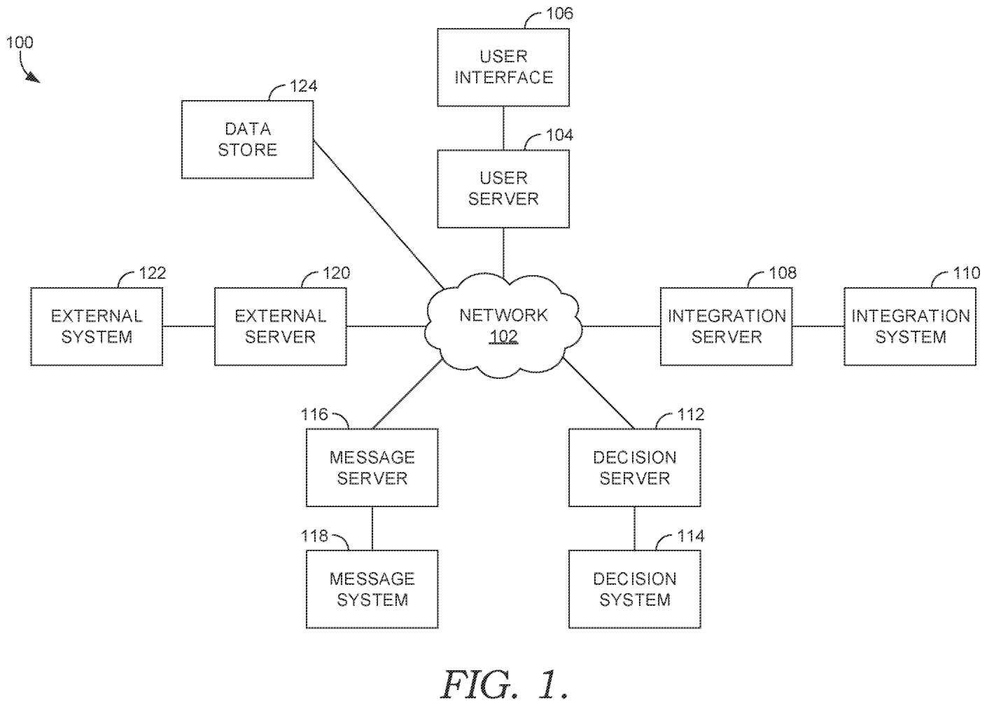

With reference now to FIG. 1, FIG. 1 is an example operating environment 100 in which aspects of the present disclosure can be employed to process and authorize a merchant credit application. As illustrated, the operating environment 100 comprises a network 102, a user server 104 associated with a user interface 106, an integration server 108 associated with an integration system 110, a decision server 112 associated with a decision system 114, a message server 116 associated with a message system 118, and an external server 120 associated with an external system 122 that can communicate with other components of FIG. 1 through the network 102.

The network 102 may include one or more networks (for example, public network or virtual private network “VPN”). In a non-limiting example, the network 102 may include one or more local area networks (LANs), wide area networks (WANs), or any other communication network or method. Each of the components in FIG. 1 may communicate directly or indirectly with other components through the network 102.

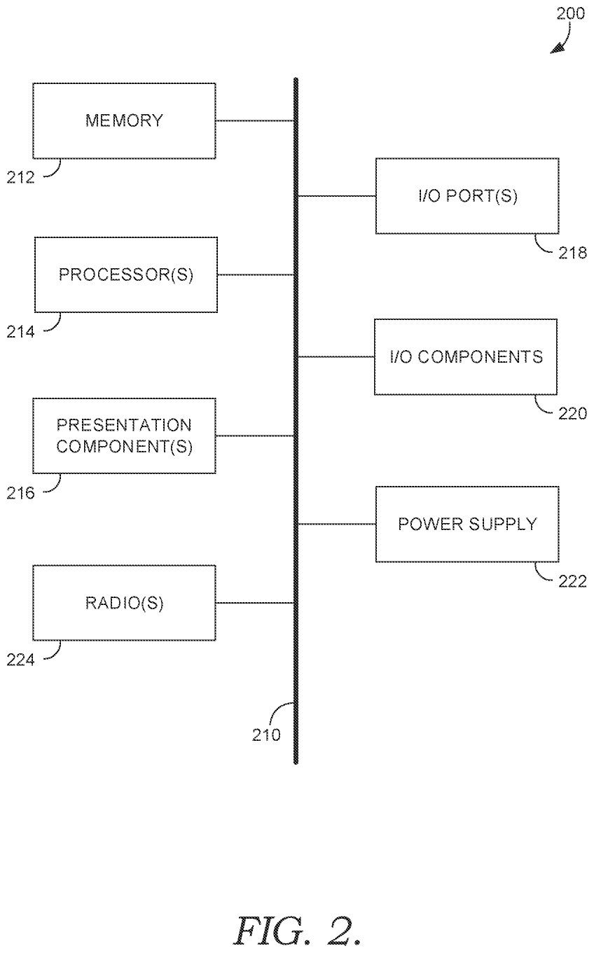

The operating environment 100 further comprises a data store 124. The data store 124 generally stores information including data, computer instructions (for example, software program instructions, routines, or services), or models used in the embodiments of the present disclosure. Although depicted as a single data store component, the data store 124 is embodied as one or more data stores or is in the cloud or other distributed architectures. One example suitable for use as the data store 124 is memory 212, discussed with reference to FIG. 2.

The data store 124 may include one or more storage devices configured to collect, store, delete, update, and/or modify data in accordance with one or more instructions received from one or more other components, the user server 104, the integration server 108, the decision server 112, the message server 116, and the external server 120. For example, the data store 124 may include any suitable combination of one or more storage mediums, such as hard disk drives, solid-state memory, cloud-based storage devices, etc. In various aspects, the data store 124 may store data in addition to or instead of data stored locally by the user server 104, the integration server 108, the decision server 112, the message server 116, and the external server 120. In doing so, the user server 104, the integration server 108, the decision server 112, the message server 116, the external server 120, the data store 124, and/or other backend components may store any suitable type of data used to facilitate various functionalities of certain aspects, as described herein.

Having identified various components of the operating environment 100, it is emphasized that any additional or fewer components, in any arrangement, may be employed to achieve the desired functionality and are within the scope of the present disclosure. Although the various components of FIG. 1 are shown with lines for the sake of clarity, the lines can illustrate a direct path of communication from one component to another or may represent a path where other intermediary components are present.

While the components of FIG. 1 are depicted as single components, the depictions are intended as examples in nature and in number and are not to be construed as limiting for all implementations of the present disclosure. Other arrangements and elements (for example machines, interfaces, functions, orders, and groupings of functions, etc.) can be used in addition to or instead of those shown, and some elements may be omitted altogether. As non-limiting examples, while the user server 104, the integration server 108, the decision server 112, the message server 116, and the external server 120 are each illustrated as a single server, it will be understood that each illustrates one or more servers working with one another in any arrangement. As another example, the data store 124 may illustrate one or more data stores provided in any arrangement throughout the operating environment 100. This may include one or more data stores 124 specifically associated with, and in communication with, each of the user servers 104, the integration server 108, the decision server 112, the message server 116, and the external server 120 to provide data and computer-usable instructions to each of their respective components. Therefore, for the sake of brevity and clarity, when the components of FIG. 1, or any other figure, are referred to in the singular, it is intended to include functions performed by one or more components working together.

The functionality of the operating environment 100 can be further described based on the functionality of the described components. That is, many of the components described in relation to FIG. 1 are entities that perform functions. Various functions described herein are being performed by one or more components and may be carried out by a hardware, a firmware, and/or a software. That is, functions performed by the components of FIG. 1 can be performed by executing computer-executable instructions stored in memory, such as the data store 124.

In general, a server, such as the user server 104, the integration server 108, the decision server 112, the message server 116, and the external server 120, comprises a processor in communication with computer-readable media. The processor executes instructions on the computer-readable media. As previously discussed, the servers illustrated as single servers can be one or more servers working to execute a particular described function.

In one aspect, the user server 104, the integration server 108, the decision server 112, the message server 116, and the external server 120 may be implemented as any suitable number and/or type of a computing device (for example, one or more computer servers) configured to communicate with other components, or one or more client interfaces, such as the user interface 106 (or suitable data stores and/or storage devices associated therewith), etc. In various aspects, the servers described above may be configured to process application programming interface (API) service calls, to support one or more applications installed on one or more devices associated with the user server 104, the integration server 108, the decision server 112, the message server 116, and the external server 120, etc.

As illustrated, the operating environment 100 comprises the user server 104 that is associated with the user interface 106 that can be any such user interface that allows the user or merchant to access accounts and pages associated with a merchant credit authorization. The user interface 106 can receive communications via the network 102 and the user server 104 and maintain accounts within the user server 104 in accordance with instructions received within the communications. For instance, the user interface 106 can identify a user's selection and input. The user interface 106 can cause to be displayed messages provided by the message system 118 and any other system that may communicate with the user interface 106 by way of the network 102. The user server 104 may also communicate instructions received from the user interface 106 by way of the network 102 to other servers, such as the integration server 108. The user interface 106 and the user server 104 are associated with the merchant applicant, an external bank, an external data store system, or any other user that may input or provide information to the network 102.

It will be understood that the integration server 108 may perform actions similar to the user server 104 on behalf of the integration system 110. Throughout the present disclosure, the integration server 108, the integration system 110 or integration service, the decision server 112, the decision system 114, the message server 116, the message system 118, the external server 120, and the external system 122 are referred to in terms of particular roles performed within the described example. However, it will also be understood that such servers and systems may perform other roles for different interactions.

It will be understood that the integration server 108 is associated with the integration system 110. The integration system 110 operates in part as a logic system that processes application data from the applicant by way of the user interface 106. The integration server 108 and the integration system 110 may operate in connection with the external system 122, the data store 124, and other systems to query various data stores, request information, or provide information to other systems and servers.

The decision server 112 on behalf of the decision system 114 may perform various activities. For instance, the decision server 112 can receive various datasets from one or more servers by way of the network 102. The decision server 112 operates using a variety of data logic systems including, but not limited to, simple rules-based logic, machine learning algorithms applied to a neural network, decision logic trees, or any other algorithm built and/or trained to make a variety of decisions based on the data provided.

In the present aspects, the decision server 112 is configured to access data from and/or store data to one or more additional data sources stored in the data store 124 that is included as one or more of backend computing devices. Additionally, or alternatively, the decision server 112 may access data from one or more servers, such as the user server 104, the integration server 108, the message server 116, and the external server 120, and/or data provided by one or more users associated with one or more user interfaces 106. In various aspects, any combination and/or subset of the aforementioned data may form a dynamic data set that changes over time as additional data is collected, and that is stored and/or updated in one or more components, such as the user server 104, the integration server 108, the decision server 112, the message server 116, and the external server 120, and transmitted by way of the network 102 and/or accessed by the decision server 112. For example, the decision server 112 may use any suitable portion of the dynamic data set as training data to train a machine learning model.

Once the machine learning model is trained in this way, the machine learning model is applied to data received to identify, predict, or decide various portions related to the process of approving or denying merchant credit application. Moreover, once such decisions, predictions, or identifications are made, aspects include the decision server 112 to receive results from a prior credit application so as to retrain or add additional training data to improve the machine learning model. The machine learning model is described here with respect to the decision server 112 and the decision system 114, but may be used with respect to any server and system described herein. For example, the integration server 108 may implement the machine learning model with respect to data retrieved by the server.

As illustrated, the operating environment 100 comprises the integration server 108 that is associated with the integration system 110. The integration server 108 can receive communications via the network 102 and maintain accounts within the integration server 108 in accordance with instructions received within the communications. For instance, the integration system 110 or the integration service may receive various portions of a merchant credit application and combine the portions into one application to be sent to the decision server 112 and the decision system 114 by way of the network 102. Additionally, the operating environment 100 comprises the message server 116, the message system 118, the external server 120, and the external system 122. Each of these systems and servers may operate in accordance with instructions received and may communicate with other servers and systems by way of the network 102. Each of the servers and systems may also retrieve information from the data store 124.

An example operating environment in which some of the present disclosure is implemented is described below in order to provide a general context for various aspects. Referring to FIG. 2, in particular, an example operating environment for implementing embodiments of the present disclosure is shown and designated generally as a computing device 200. The computing device 200 is an example of a suitable computing environment and is not intended to suggest any limitation as to the scope of use or functionality of the technology, and nor should the computing device 200 be interpreted as having any dependency or requirement relating to any one or combination of components illustrated.

The technology of the present disclosure is described in the general context of computer code or machine-useable instructions, including computer-executable instructions, such as program modules, being executed by a computer or other machine, such as a personal data assistant or other handheld device. Generally, the program modules including routines, programs, objects, components, data structures, etc., refer to a code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 2, the computing device 200 includes a bus 210 that directly or indirectly couples the following devices: the memory 212, one or more processor(s) 214, one or more presentation component(s) 216, input/output port(s) 218, input/output components 220, and illustrative power supply 222. The bus 210 represents what may be one or more buses (such as an address bus, data bus, or a combination thereof).

Although the various blocks of FIG. 2 are shown with lines for the sake of clarity, in reality, delineating various components is not so clear, and metaphorically, the lines would more accurately be grey and fuzzy. For example, one may consider a presentation component, such as a display device, to be an I/O component 220. As another example, processor(s) 214 may also have memory. Such is the nature of the art, and it is again reiterated that the diagram of FIG. 2 merely illustrates an example computing device that can be used in connection with one or more embodiments of the present disclosure. Distinction is not made between such categories as “workstation,” “server,” “laptop,” “handheld device,” etc., as all are contemplated within the scope of FIG. 2 and make reference to the “computing device.”

The computing device 200 typically includes a variety of computer-readable media. The computer-readable media can be any available media that can be accessed by the computing device 200 and includes both volatile and non-volatile media, and removable and non-removable media. By way of non-limiting example, the computer-readable media may comprise computer storage media and communication media.

The computer storage media includes volatile and non-volatile media, removable and non-removable media implemented in any method or technology for storage of information, such as computer-readable instructions, data structures, program modules, or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium that can be used to store the desired information that can be accessed by the computing device 200. The computer storage media excludes signals per se.

The communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information associated therewith. By way of non-limiting example, the communication media includes wired media, such as a wired network or direct-wired connection, and wireless media, such as acoustic, RF, infrared, and other wireless media. Combinations of any of the above should also be included within the scope of computer-readable media.

The memory 212 includes computer storage media in the form of volatile or non-volatile memory. The memory 212 may be removable, non-removable, or a combination thereof. Example hardware devices include solid-state memory, hard drives, optical-disc drives, etc. The computing device 200 includes one or more processor(s) 214 that read data from various entities, such as the memory 212 or the I/O components 220. The presentation component(s) 216 present data indications to a user or other device. Examples of the presentation component(s) 216 include a display device, speaker, printing component, vibrating component, etc.

The I/O port(s) 218 allow the computing device 200 to be logically coupled to other devices, including the I/O components 220, some of which may be built in. Illustrative components include a microphone, joystick, game pad, satellite dish, scanner, printer, wireless device, and the like.

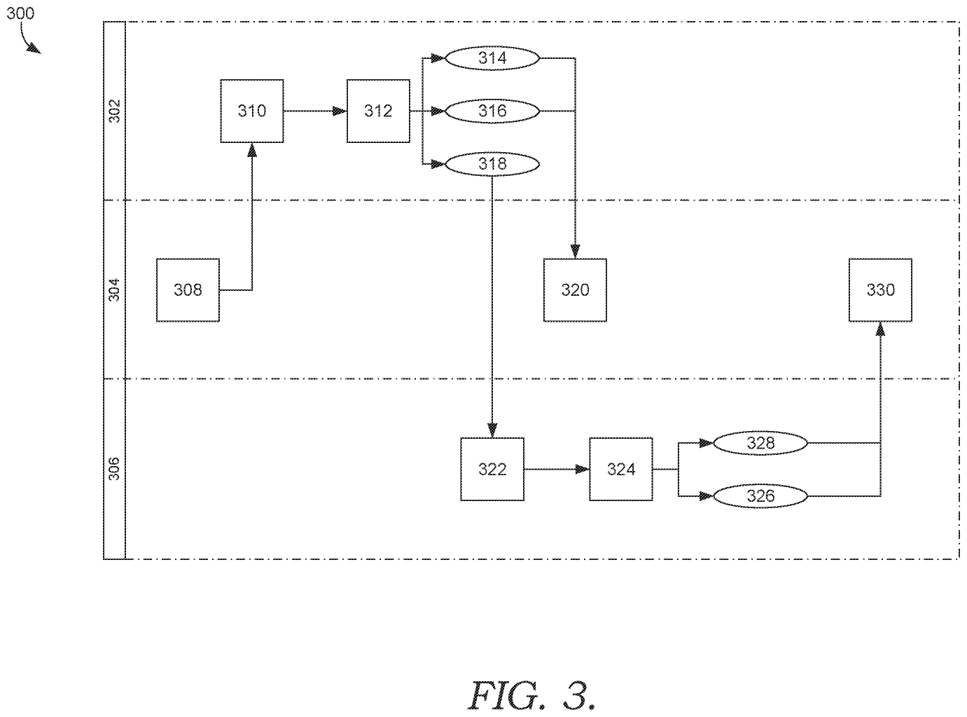

Turning now to FIG. 3, FIG. 3 represents an example process flow 300 that can be performed by components of the operating environment of FIG. 1 and the computing device 200 of FIG. 2, in accordance with an aspect described herein. The process flow 300 comprises three general services. The process flow 300 comprises a credit issuer service 302, an application service 304, and a merchant service 306. Each of the services corresponds to one or more servers and systems previously described herein. It is noted that the procedures are examples, and that other arrangements may be possible. All of these aspects, including various other arrangements, will be apparent to those of ordinary skill in the art in view of the present disclosure, and such aspects are contemplated within the scope of the present disclosure. While the process flow 300 is described as a series of steps, it should be recognized that these steps are illustrative and not intended to limit the present disclosure to the specific aspect illustrated in FIG. 3.

Application service 304 refers to a technological solution that enables users to apply for various services or programs through a digital platform. This service leverages the processors and digital interfaces to streamline and simplify the application process, making it more accessible, efficient, and user-friendly. Furthermore, the application service may employ advanced technologies such as data validation, automated checks, and real-time feedback to ensure the accuracy and completeness of the application. This helps users identify and correct errors or omissions, reducing the chances of application rejections or delays.

The application service 304 may provide an exemplary interface that allows the applicant, the merchant, or the credit issuer to start the merchant credit application by entering data into the user interface. In one example, the application service 304 may be a web-based application that requires the user to provide user authentication or identification to access the merchant credit application. The application service 304 may also provide selectable and fillable form fields that may detail what is required by the user or the merchant applicant for a complete merchant credit application. A user inputs applicant information into the user interface. In one aspect, the merchant info is saved or input into the application service 304 that may be associated with a database or data store, such as the data store 124 in FIG. 1.

In the back end of the application service 304, various technologies work together to handle the processing and management of applications. These technologies include: Database Management Systems (DBMS), such as MySQL, Oracle, or MongoDB, to store and manage application data. The DBMS ensures secure and efficient storage, retrieval, and organization of application information. Application service 304 may employ server-side programming languages like Python, Java, or PHP to handle application logic and data processing. These languages enable the implementation of business rules, data validation, and integration with other systems or APIs. Backend frameworks like Django, Ruby on Rails, or Node.js provide a structured environment for developing and deploying application services. They offer prebuilt modules, libraries, and tools that simplify the development process and enhance efficiency. Application service 304 systems integrate with external APIs to gather additional information or perform verification processes during the application review. APIs allow seamless communication with external services such as credit bureaus, identity verification services, or document validation services. Application service 304 may also incorporate authentication mechanisms, such as OAuth or JSON Web Tokens (JWT), to ensure secure access to the application service. They implement encryption protocols (e.g., SSL/TLS) to protect data transmission and employ security measures to prevent unauthorized access or data breaches.

In some examples, the application service 304 communicates with external services through various mechanisms such as web APIs, protocols, and data formats. The application service 304 API can use Representational State Transfer (REST) principles to communicate with external services. RESTful APIs use HTTP methods like GET, POST, PUT, and DELETE to perform operations on remote resources. The API sends requests to the external service's endpoints, receives responses in JSON or XML format, and processes the data accordingly. A SOAP (Simple Object Access Protocol) may be used for exchanging structured information over web services. The Application Service API can send SOAP requests to external services using XML-based messages. SOAP APIs often use Web Services Description Language (WSDL) files to define the operations and data structures.

In other examples, the application service 304 uses a GraphQL query language and runtime for APIs. This allows the application service 304 to request specific data and shape the response, such as external retrieval 310. The Application Service API can use GraphQL to send queries or mutations to external services, specifying the required data fields and relationships. GraphQL APIs often respond with JSON payloads containing the requested data. The application service 304 can communicate with external services through message queues such as RabbitMQ or Apache Kafka. Application service 304 can publish messages containing relevant information or requests to the queue, and external services subscribed to the queue can consume those messages, process them, and provide responses.

In some cases, the application service 304 may communicate with external services, or any other services described herein, by exchanging files. This can involve uploading files to external services via FTP or SFTP, or retrieving files through secure protocols like HTTP. Further, to communicate with external services, or any other service described herein, the application service 304 may need to authenticate itself and obtain authorization. This can involve using API keys, OAuth tokens, or other authentication mechanisms provided by the services.

In some embodiments, the application service 304 may communicate with external servers to obtain information. In other embodiments, the credit issuer service 302 may communicate with external servers and systems in like manners, as described in relation to the application service 304. For example, the credit issuer service 302 may require that the application service 304 provide some manner of authentication mechanism, such as an API key.

In some embodiments, a hardware security module (HSM) can be incorporated into the architecture of the application service 304, credit issuer service 302, or merchant service 306 to enhance the security of sensitive data and cryptographic operations. In one example, an HSM can be used to securely generate, store, and manage cryptographic keys used by the application service 304 or any other service provided herein. The HSM protects the keys from unauthorized access and provides secure key storage capabilities, ensuring the confidentiality and integrity of the keys. The HSM can offload and perform cryptographic operations, such as encryption, decryption, digital signing, and verification. Instead of performing these operations in the application service's software layer, the sensitive cryptographic operations are securely executed within the tamper-resistant environment of the HSM. This helps to protect against attacks and ensures the integrity of cryptographic processes.

The HSM can provide secure storage for sensitive data, such as encryption keys, passwords, or credentials. By utilizing the HSM's secure storage capabilities, the application service 304, the credit issuer service 302, and the merchant service 306 can store sensitive data in an encrypted form within the HSM, reducing the risk of data exposure or unauthorized access. HSMs are designed with physical security measures to protect against tampering, including tamper-resistant casings, intrusion detection mechanisms, and self-destruct capabilities. By incorporating an HSM, the application service 304, the credit issuer service 302, and merchant service 306 benefit from the robust physical security of the hardware, mitigating risks associated with physical attacks on the system. The HSM can enforce strict access controls and authentication mechanisms to ensure that only authorized entities can utilize the cryptographic keys and perform operations within the HSM. This strengthens the security of the application service by preventing unauthorized access to sensitive cryptographic operations and key material.

In some embodiments, HSMs often provide built-in logging and auditing capabilities, allowing for comprehensive tracking of cryptographic operations and key management activities. This supports compliance requirements and enables monitoring, review, and analysis of security-related events. When incorporating an HSM, the application service 304, the credit issuer service 302, and merchant service typically interact with the HSM via a standardized interface or API, which allows secure communication and control over the HSM's functionality. The HSM may be physically integrated into the infrastructure hosting the application service or accessed remotely as a dedicated hardware device or a cloud-based HSM service.

The credit issuer service 302 represents a technological solution provided by financial institutions, merchant credit companies, or business-to-business credit companies to manage and facilitate the issuance of credit to consumers or businesses. This service leverages technology to assess creditworthiness, generate risk metrics, monitor transactions, and streamline credit-related processes. Through the credit issuer service 302, financial institutions can utilize sophisticated algorithms and machine learning models to evaluate applicants' credit profiles and determine their creditworthiness. These technologies analyze various factors such as credit history, income, debt levels, and payment patterns to make data-driven decisions regarding credit approval and credit limits. Moreover, the credit issuer service incorporates advanced fraud detection mechanisms to identify and prevent fraudulent transactions. It can leverage real-time transaction monitoring, anomaly detection, and pattern recognition to swiftly detect suspicious activities and mitigate potential risks. Additionally, the credit issuer service 302 provides merchant users with digital access to their credit information, account management tools, and secure payment options. This empowers businesses to conveniently track their credit usage, make payments, and manage their credit accounts using online portals or mobile applications.

In some embodiments, the credit issuer service 302 may use advanced machine learning algorithms to analyze credit-related data and generate risk metric scores. These algorithms consider factors like credit history, income, debt-to-income ratio, business age, business with consumer information, business without consumer information, and payment behavior to determine creditworthiness. The credit issuer service 302 may also utilize decision engines that apply predefined rules and algorithms to evaluate credit applications, as described in more detail below. These engines process the credit scores and other relevant data to make automated decisions regarding credit approval, credit limits, and interest rates. The credit issuer service 302 may employ data analytics tools and techniques to gain insights from credit-related data. These technologies enable the identification of patterns, trends, and risk factors, facilitating more informed decision-making.

In other embodiments, the credit issuer service 302 may integrate with fraud detection systems that employ machine learning algorithms and anomaly detection techniques to identify and prevent fraudulent activities. These systems analyze transaction data in real-time, flagging suspicious patterns or behaviors for further investigation. The credit issuer service 302 can establish integrations with credit bureaus to access credit reports and obtain up-to-date credit information of applicants. This integration allows for accurate assessment of creditworthiness based on comprehensive credit data.

The merchant service 306 is a technological solution that leverages a risk metric generated by the credit issuer service 302 to make credit decisions. It allows merchants to independently approve or deny a user's credit application, even after the credit issuer has initially denied it. In this scenario, the merchant service 306 assumes the credit risk associated with the user's application. The merchant service 306 operates as a platform or system that facilitates credit evaluation and decision-making for merchants. It integrates with the credit issuer service 302 to receive a risk metric that has been generated based on the user's credit application.

When a user submits a credit application, the credit issuer service 302 processes the application data and generates a risk metric that reflects the user's creditworthiness. This risk metric is then securely transmitted to the merchant service 306. Upon receiving the risk metric, the merchant service 306 utilizes it as a key input for its credit decision process. The merchant can independently review the risk metric, along with other relevant information, such as the user's application details and supporting documentation.

Based on the risk metric and any additional criteria specified by the merchant, the merchant service 306 enables the merchant to make an informed credit decision.

The merchant can assess the risk associated with the user's credit application and decide whether to approve or deny it, considering their own risk tolerance and business considerations. If the merchant chooses to approve the user's credit application, they assume the credit risk associated with providing the requested credit or extending the user's credit limit. Through the integration of the credit issuer service 302 risk metric, the merchant service 306 empowers merchants to make credit decisions based on a comprehensive assessment of the user's creditworthiness. This integration allows merchants to consider additional factors beyond the credit issuer's initial decision, providing them with more flexibility and the ability to offer credit opportunities to users who may have been denied by traditional credit issuers. The merchant service 306 ensures secure communication and data protection measures to safeguard the risk metric and sensitive user information. It may also provide reporting and monitoring functionalities to assist merchants in tracking credit performance and managing credit risk effectively.

In some embodiments, the merchant service 306 integrates with the credit issuer service 302 through APIs or data connectors to receive the risk metric generated by the credit issuer service. This integration ensures seamless data flow between the services, enabling the merchant service 306 to access the risk metric for credit evaluation. The merchant service 306 includes components for securely processing and storing data related to credit applications and risk metrics. This involves utilizing database management systems (DBMS) such as MySQL or PostgreSQL to store and retrieve relevant information, ensuring efficient data organization and retrieval. The merchant service 306 may employ algorithms and machine learning to analyze the risk metric received from the credit issuer service 302. These algorithms assess the risk metric along with other criteria specified by the merchant to determine the creditworthiness of the user's application. This analysis may involve comparing the risk metric against predefined thresholds or rules to make an informed credit decision. The merchant service 306 may also incorporate a credit decision engine that applies the defined credit evaluation rules and algorithms. The credit decision engine evaluates the risk metric, user application details, and any additional merchant-specific criteria to generate a credit decision, such as approval or denial of the credit application. Merchant service 306 may also enforce secure authentication mechanisms and access controls to ensure that only authorized personnel can access and perform credit evaluations within the Merchant Service. This helps protect sensitive user data and ensures the integrity of the credit decision-making process.

Merchant service 306 employs secure communication protocols (e.g., HTTPS) and data encryption techniques to protect the transmission and storage of sensitive data, including the risk metric received from the credit issuer service. Encryption mechanisms safeguard the integrity and confidentiality of the data, mitigating the risk of unauthorized access or data breaches. Additionally, the merchant service 306 incorporates logging and auditing functionalities to record credit decision-making processes, user interactions, and system activities. This enables monitoring, review, and analysis of credit decisions, providing an audit trail for compliance purposes and troubleshooting potential issues.

Within the application service 304, an applicant such as a user or a business entity desiring to be issued credit through the credit issuer to be used with the merchant associated with the merchant service 306 provides a credit application through the application service 304 at step 308. This can be done via an online form, an application portal, or an API request. The application typically includes personal or business details, financial information, employment history, references, and any other relevant data required for the credit evaluation process. The application service 304, as part of the applicant process, collects the credit application data provided by the applicant. This involves securely capturing the information and ensuring its integrity during transmission. The service may employ encryption and other security measures to safeguard the sensitive data.

Additionally, at the application entry step 308, the application service 304 may perform validation and verification checks on the provided data. This step ensures that all mandatory fields are completed, and the data is formatted correctly. The service may conduct basic verification checks, such as confirming the accuracy of contact information or validating certain identification details. If the credit application requires supporting documentation, the application service 304 provides a mechanism for the applicant to upload the necessary files. This could include documents such as identification cards, financial statements, tax records, or any other documents relevant to the credit evaluation process.

The application service 304 at the application entry step 308 processes the credit application data to prepare it for further evaluation. This may involve data transformation, normalization, or cleansing to ensure consistency and accuracy. The service may also extract key information from uploaded documents using OCR (Optical Character Recognition) or other document processing techniques. The processed credit application data is securely stored within the application service 304 backend systems. This typically involves using a database management system (DBMS) or secure storage infrastructure to ensure the confidentiality, integrity, and availability of the data. After processing the credit application data, the application service 304 communicates with the credit issuer service 302 to provide the necessary information for the credit evaluation process. This may involve transmitting the credit application data, relevant documents, and any additional metadata required for a comprehensive assessment. This communication may be done in accordance with steps described above in relation to the two services communicating.

Once the credit issuer service 302 receives the credit application and the information and documents associated with it, the credit issuer service 302 processes the data and retrieves external credit information at external retrieval 310 associated with the applicant. The credit issuer service 302 may query an external database related to the business entity or applicant. The query by the credit issuer service 302 to the external sources is based at least in part on the merchant-entered info in the application process step 308. The credit issuer service 302 may directly communicate with the credit insurer by way of an API. The external retrieval 310 may retrieve credit reports and scores from credit bureaus and reporting agencies. These reports provide information about the business's credit history, payment patterns, outstanding debts, and public records such as bankruptcies or liens. Credit reports help assess the business applicant's creditworthiness and evaluate its ability to meet financial obligations. The application service 304 can access business credit reports that provide specific details about the business's credit performance, payment history, and credit utilization. These reports may include information from credit bureaus specialized in business credit reporting, such as Dun & Bradstreet or Experian Business. The external retrieval 310 may search public records databases to retrieve information on legal filings, liens, judgments, or bankruptcies associated with the business. These records help assess the business's legal and financial standing, identify potential risks, and evaluate its overall stability. In further embodiments, the external retrieval 310 may access databases or platforms maintained by regulatory bodies or licensing authorities to verify the business's compliance with industry-specific regulations, licenses, or permits. This information helps assess the business's legal status, adherence to industry requirements, and potential risks associated with non-compliance. Business details also may contain information related to the duration that the business has been established. The external retrieval 310 may contact trade references provided by the business applicant to gather information about the business's payment history and trade relationships. These references may include suppliers, vendors, or other businesses with whom the applicant has conducted transactions. Insights from trade references contribute to evaluating the business's reliability and creditworthiness.

The external retrieval 310 may retrieve industry-specific data or market research reports relevant to the business applicant's sector. This information may be insights into market trends, competitive landscape, and the overall health of the industry. The external retrieval may leverage web scraping techniques or APIs to retrieve information from public websites, business directories, or social media platforms. This can include gathering details about the business's online presence, customer reviews, social media activity, or news articles. Online data sources offer additional context and insights into the business's reputation and public perception. Additionally, the external retrieval 310 may collaborate with financial institutions or banks to access information about the business's banking history, existing loans, or credit relationships. This data contributes to evaluating the business's financial stability, cash flow management, and creditworthiness.

In some instances, the business entities within the external retrieval 310 are stored in a non-standardized form. For example, the external database can store business information in an array, linked list, stack, queue, hash table, tree, heap, graph, or any other data form. The credit issuer service 302 may retrieve business information from multiple database sources, each having a different non-standardized form. Additionally, the external databases accessed can also change a form of storage of the data. By using the volatility-based decomposition architecture, the external data may be modified so as to be able to convert new types or forms of data structure to a data form used by the credit issuer service 302.

Once the non-standardized data is retrieved from the external database, the credit issuer service 302 converts the non-standardized data into a risk metric. The risk assessor 312 involves analyzing the gathered information and assigning a numerical value or score that represents the level of risk associated with extending credit to the applicant. The risk assessor 312 may identify the key risk factors that will be considered in the risk assessment process. These factors may include credit history, financial stability, industry risk, payment patterns, legal or regulatory compliance, and any other relevant aspects specific to the credit evaluation criteria. The risk assessor 312 may assign relative weights to each risk factor based on their importance in the credit evaluation process. The weights reflect the significance of each factor in determining the overall risk level. For example, credit history might be given a higher weight than industry risk if it is considered a critical factor. Next, the risk assessor may define a scoring mechanism for each risk factor. This involves establishing a scale or range that quantifies the level of risk associated with each factor. For instance, credit history might be scored on a scale of 1 to 5, with 1 representing excellent credit and 5 indicating poor credit.

In additional embodiments, the risk assessor 312 may evaluate each risk factor based on the data collected from both internal and external sources and assign the appropriate score to each factor based on the applicant's specific information. This evaluation can be performed through algorithms or decision models. Subsequently, the scores of each risk factor are multiplied by their respective weights to reflect their relative importance. This step allows for an overall assessment of the applicant's risk level, considering the different factors and their significance.

The risk assessor 312 may sum up the weighted scores across all risk factors to calculate an aggregate risk score for the applicant. This score represents the overall level of risk associated with extending credit to the applicant. It can be scaled to a standardized range or transformed into a percentile to provide a comparative measure. Risk categories or levels are defined based on the aggregate risk score. These categories can range from low risk to high risk or can be divided into specific risk tiers. This classification helps in quickly identifying and categorizing the level of risk associated with each applicant.

In further embodiments, the risk assessor continuously reviews and refines the risk metric based on historical data and ongoing analysis and regularly assesses the effectiveness of the risk metric in predicting credit performance and adjusts the scoring or weighting as needed to improve accuracy. The generation of a risk metric by the risk assessor 312 may be a numerical score based on the determined risk. This is a categorical evaluation of a large amount of data to provide a merchant with an easier method of determining whether to approve the credit application of the user.

Once the risk metric is generated, the credit issuer service 302 may then determine if they will issue credit to the applicant. The risk metric analysis may lead to three potential outcomes: approved 314, denied 316, or gray area 318. If the application falls within a predetermined acceptable risk threshold set by the credit issuer associated with the credit issuer service 302, the credit application is approved. This indicates that the applicant's creditworthiness meets the desired criteria, and they are considered low risk. The approval allows the applicant to access the requested credit or credit services.

If the risk metric exceeds the predetermined acceptable risk threshold, the credit application is denied 316. This implies that the applicant's creditworthiness does not meet the required standards or is considered too risky for credit extension. The denial indicates that the lending institution or credit issuer determines the applicant's creditworthiness as insufficient or potentially high risk, leading to the denial of the credit application.

In some cases, the risk metric may fall within a range that is neither clearly above nor clearly below the predetermined risk thresholds. This gray area 318 indicates a level of uncertainty or ambiguity in the credit decision. Further evaluation or additional information may be necessary to make a definitive determination. If the risk metric falls within the gray area region, the credit issuer may allow the merchant to approve or deny the application while taking on the risk themselves. In this case, the merchant holds the risk and the credit issuer still processes the credit the same as if they had issued the credit under a normal approved 314 situation.

At step 320, once a credit application has been approved or denied, the applicant is notified of the decision at the application service 304. The application service 304 generates a notification or communication to inform the applicant about the decision on their credit application. The notification is typically sent through a preferred communication channel specified by the applicant, such as email, SMS, or an online portal. It provides clear and concise information about whether the application has been approved or denied.

If the credit application is approved 314, the application service proceeds with the normal processing of the credit for the approved applicant. This involves initiating the necessary steps to grant the requested credit or credit services to the applicant, based on the terms and conditions specified by the lending institution or credit issuer. The approved applicant may be required to review and sign a credit agreement or other relevant documentation. This agreement outlines the terms, conditions, interest rates, repayment schedules, and any other contractual obligations associated with the approved credit. The applicant acknowledges their understanding and acceptance of the terms by signing the agreement. Once the credit agreement is signed, the credit issuer service 302 proceeds with the disbursement of the approved credit amount to the applicant. Following the credit approval and disbursement, the credit issuer service 302 may provide the applicant with access to an online account or portal where they can manage their credit account. This account management interface allows the approved applicant to view account balances, make payments, track transactions, and access relevant account information.

In the case where the risk metric indicates that there is some ambiguity or falls within a predetermined range of a gray area, the application along with the risk metric may be sent to the merchant service 306 for further review at step 322. The application is sent but the entire external data is not sent; rather, the novel risk metric associated with the applicant is sent. This allows the merchant to review the application and make a determination as to whether or not merchant, rather than the issuer, will take the risk and approve the applicant.

The merchant risk evaluator 324 may then take the application and analyze all of the information received at step 322. When the risk metric for an applicant falls within the gray area, indicating an uncertain level of risk, the merchant service 306 may initiate a more detailed evaluation of the credit application. This involves reviewing additional information, conducting further analysis, and considering supplementary factors to make an informed credit decision. The merchant service 306 may request the applicant to provide additional documentation or information that can help clarify any uncertainties or address specific concerns related to the credit application. This could include financial statements, business references, or any other relevant data that can assist in the evaluation process.

The merchant service 306 may establish a decision-making framework or guidelines specifically designed to handle gray area applications. This framework provides a structured approach to considering various factors, evaluating risk indicators, and weighing the potential benefits and risks associated with approving the application. This may include prior dealings with the applicant or other factors that may be weighted into the decision. The decision made by the merchant service 306 may be automated using a system where the risk metric is further categorized into “approve” or “deny” predetermined thresholds. Further, the merchant service 306 may determine that the merchant must make a further manual review and may then advise a manager that the applicant must be reviewed.

The merchant service 306 may then determine that the application is approved 328 or denied 326. If the merchant service 306 denies 326 the application, the applicant is notified at step 330 that the application has been denied and may be notified of any possible further steps. The applicant is promptly notified at step 330 that their credit application has been denied. This notification is typically sent through a preferred communication channel, such as email, SMS, or an online portal. The notification informs the applicant of the denial decision and may provide a brief explanation for the denial, highlighting the factors that contributed to the decision. The denial notification may also include information about possible further steps that the applicant can take. These steps could involve an appeal process or the option to request a manual review of the credit application. By offering these options, the merchant service provides an avenue for applicants to address any potential errors or provide additional information that could influence the credit decision. If the applicant believes that the denial decision was based on incorrect or incomplete information, they may choose to initiate an appeal. The appeal process typically involves submitting a formal request along with any supporting documentation or explanations that can help strengthen the creditworthiness argument. The merchant service 306 or the credit issuer service 302 then reviews the appeal and reevaluates the credit application based on the additional information provided.

If the merchant service 306 indicates that the application is approved 328, the applicant is then notified that the credit issuer will issue credit. However, in the case that the merchant service 306 has approved 328 the application, the merchant is assuming all credit risk, not the credit issuer. In this case the applicant is not notified that the risk is being taken by the merchant. Although the applicant is not explicitly informed that the credit risk is being assumed by the merchant rather than the credit issuer, it is an underlying understanding within the merchant service 306 process. The credit issuer's role may include facilitating the disbursement of the approved credit amount or providing support services, while the merchant assumes the risk associated with the approved credit. The credit issuer also assumes the role of payment collector and may collect due and past due payments.

Once approved by either the credit issuer or the merchant, the applicant is notified and credit is issued by the credit issuer service 302. The credit issuer service 302 prepares a credit agreement that outlines the terms, conditions, and obligations associated with the approved credit. This agreement includes details such as the approved credit limit, interest rates, repayment schedule, and any applicable fees or charges. The approved applicant is required to review, sign, and return the credit agreement to indicate their acceptance of the terms. Upon receiving the signed credit agreement, the credit issuer service 302 sets up a credit account for the approved applicant. This involves assigning a unique account number, creating account records, and linking the account to the applicant's identification and contact details.

Depending on the type of credit, the credit issuer service 302 may disburse the approved credit amount to the approved applicant in one or multiple disbursements. For example, in the case of a credit card, the credit issuer may issue the physical card and activate the credit line associated with it. In other cases, funds may be transferred directly to the approved applicant's designated bank account. The credit issuer service 302 establishes a payment schedule that outlines the due dates, minimum payment amounts, and other relevant payment terms. The billing cycle is determined, specifying the period for which transactions and charges are accumulated before generating the monthly statement. The credit issuer service 302 generates monthly statements that detail the transactions made on the credit account during the billing cycle. The statement provides a summary of the outstanding balance, available credit, transaction details, and any applicable fees or interest charges. It serves as a record of the credit activity and provides a clear overview of the payment obligations. The credit issuer service 302 sends payment reminders to the approved applicant before the payment due date. These reminders can be in the form of electronic notifications, emails, SMS messages, or physical letters, providing a reminder of the upcoming payment and the amount due.

The credit issuer service 302 collects payments from the approved applicant based on the established payment schedule. Payments can be made through various channels, including online payment portals, bank transfers, checks, or automatic deductions from a designated bank account. The credit issuer processes the received payments, updates the account balance, and reflects the payment status in the applicant's credit account. Throughout the credit period, the credit issuer service 302 monitors the approved applicant's account for any irregularities, non-payment, or potential credit risks. The credit issuer service 302 provides customer support services to address inquiries, clarify billing concerns, and assist with any account-related issues.

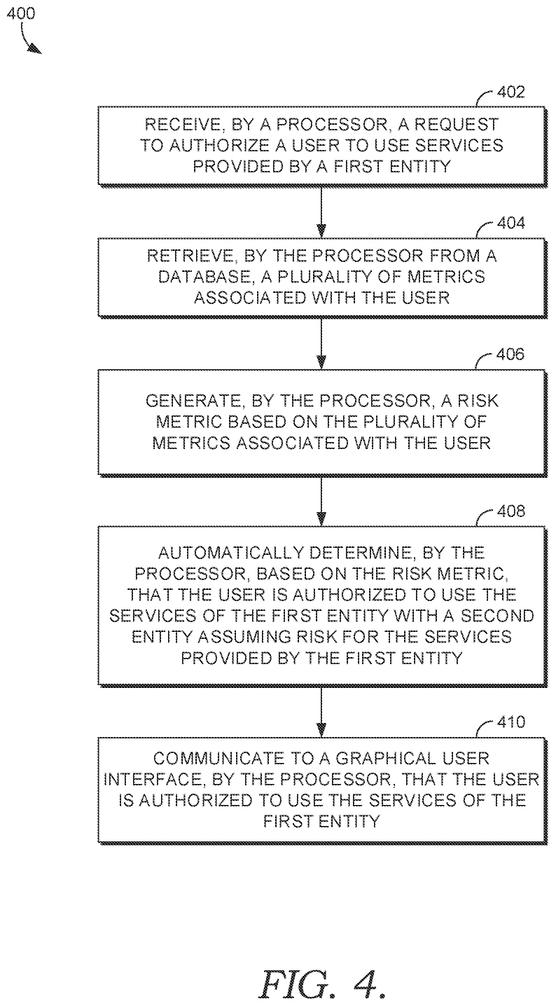

FIG. 4 illustrates an example method 400 for processing a credit application, in accordance with an aspect described herein. At block 402, a processor within the system receives a request to authorize a user for accessing and using services provided by a first entity. This request typically originates from the user or a system acting on behalf of the user. The processor acts as the central point for handling and processing these authorization requests, ensuring the secure and seamless provision of services to the user. Upon receiving the request, the processor initiates the necessary procedures to validate the user's credentials, permissions, and eligibility to access the services offered by the first entity. This may involve checking user authentication, verifying account details, evaluating user roles and permissions, and cross-referencing with relevant databases or authorization rules. The processor plays a crucial role in enabling a smooth and efficient authorization process, ensuring that only authorized users gain access to the application.

At block 404, the processor retrieves a plurality of metrics associated with the user from a database. This step involves accessing a structured database that stores user-related information and metrics relevant to the authorization and evaluation process. The processor queries the database using the user's unique identifier or other identification parameters to retrieve the specific metrics associated with that user. These metrics can include a wide range of data points, such as historical usage patterns, transaction history, account balances, performance metrics, risk scores, or any other relevant metrics associated with the user's interactions with the first entity's services. By retrieving these metrics, the processor gains valuable insights into the user's past behavior and performance, enabling a more comprehensive evaluation and decision-making process during the authorization and service provisioning stages.

At block 406, the processor generates a risk metric based on the plurality of metrics associated with the user. This step involves analyzing and processing the retrieved metrics to assess the level of risk associated with authorizing the user for the services provided by the first entity. The processor applies predefined algorithms, rules, or machine learning models to the collected metrics, taking into account various factors such as historical behavior, financial data, performance indicators, and any other relevant metrics. The generated risk metric serves as a quantifiable representation of the user's creditworthiness, trustworthiness, or overall risk level. It provides an objective measure that helps in evaluating the user's eligibility for accessing the services and informs decision-making processes related to the authorization. The risk metric can take different forms depending on the specific requirements and models used. It may be a numerical score, a risk category or level, or a combination of factors that contribute to an overall risk assessment. This metric assists in determining the user's suitability for accessing the services, considering factors such as its ability to meet financial obligations, adherence to compliance standards, past performance, and potential risk factors. By generating a risk metric based on the user's metrics, the processor enables a systematic evaluation of the user's risk profile. This metric helps the processor make informed decisions regarding the authorization process, balancing the need to provide access to services while mitigating potential risks associated with the user.

At block 408, the processor automatically determines, based on the risk metric generated, whether the user is authorized to use the services of the first entity. This determination is made in conjunction with a second entity assuming the risk for the services provided by the first entity. The processor evaluates the risk metric generated in the previous step (block 406) to assess the user's level of risk. The risk metric serves as a key input in determining the user's creditworthiness, trustworthiness, or overall risk profile. The processor compares the risk metric against predefined risk thresholds or policies established by the second entity. These thresholds define the acceptable level of risk that the second entity is willing to assume for authorizing the user's access to the services provided by the first entity. Based on the risk metric evaluation and the alignment with the risk thresholds, the processor automatically determines whether the user is authorized to use the services of the first entity. If the user's risk metric falls within the acceptable risk thresholds set by the second entity, the processor proceeds with the authorization process. This means that the user is granted access to the services, with the second entity assuming the associated risks. The involvement of the second entity signifies that it is assuming the risk for the services provided by the first entity. This arrangement allows the user to access the services despite their risk level, as the second entity agrees to bear the potential consequences or losses associated with providing those services.

Additionally, the system and method may identify if the second entity that may assume the risk for the services has sufficient risk or credit to issue to the applicant. For example, if the merchant for which credit is desired to be obtained for has a pre-approved credit risk limit of $500,000, and has already leveraged $350,000, the merchant has an available risk or credit to issue of $150,000.

At block 410, the processor communicates to a graphical user interface (GUI) that the user is authorized to use the services of the first entity. This step involves providing a clear and user-friendly interface to convey the authorization decision to the user. The processor retrieves the authorization decision made in the previous step (block 408), which determined that the user is authorized to use the services of the first entity. The processor interfaces with a GUI, which is a visual representation of the application or system that the user interacts with. The GUI can be a web application, a mobile app, or any other interface that allows the user to access and utilize the services of the first entity. The processor sends a notification or updates the GUI to indicate that the user has been authorized to use the services. This notification typically includes information about the approved access, the available services, and any relevant terms or conditions. The GUI may visually highlight the authorized status, such as displaying a confirmation message, changing the status indicator to reflect authorization, or providing access to previously restricted features or functionalities. Once the authorization is communicated, the user gains full or limited access to the services provided by the first entity, depending on the specific authorization decision and the associated permissions granted. The GUI ensures that the communication regarding the authorization is presented in a user-friendly manner. It provides clear and concise information, ensuring that the user understands their authorized access and any associated limitations or requirements.

Embodiments described above are combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present disclosure is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having,” or variations thereof, has the same broad meaning as the word “comprising,” and the word “accessing,” or variations thereof, and comprises “receiving,” “referencing,” or “retrieving.” Further, the word “communicating,” or variations thereof, has the same broad meaning as the word “receiving” or “transmitting” facilitated by software or hardware-based buses, receivers, or transmitters using communication media. Also, the word “initiating” or “invoking,” or variations thereof, has the same broad meaning as the word “executing” or “instructing” where the corresponding action can be performed to completion or interrupted based on an occurrence of another action.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of a detailed discussion above, embodiments of the present disclosure are described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present disclosure may generally refer to the distributed data object management system and the described schematics, it is understood that the techniques described may be extended to other implementation contexts.

From the foregoing, it will be seen that the present disclosure may be well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated in the accompanying drawings is to be interpreted as illustrative and not in a limiting sense.

What is claimed is:

1. One or more non-transitory computer storage media storing computer-readable instructions that, when executed by one or more processors, cause the one or more processors to perform operations for a user application, the operations comprising:
receiving, by a processor, a request to authorize a user to use services provided by a first entity;
retrieving, by the processor from a database, a plurality of metrics associated with the user;
generating, by the processor, a risk metric based on the plurality of metrics associated with the user;
automatically determining, by the processor, based on the risk metric, that the user is authorized to use the services of the first entity with a second entity assuming risk for the services provided by the first entity; and
communicating to a graphical user interface, by the processor, that the user is authorized to use the services of the first entity.

2. The one or more computer storage media of claim 1, further comprising notifying the user that the user is authorized to use the services of the first entity and providing information regarding any further steps that the user can take in response to a denial.

3. The one or more computer storage media of claim 1, wherein the plurality of metrics associated with the user comprises credit history, payment patterns, outstanding debts, and public records.

4. The one or more computer storage media of claim 2, wherein the first entity match is at least a partial match with the user based on a similarity between the plurality of metrics related to the user and a set of data related to the first entity.

5. The one or more computer storage media of claim 1, wherein the risk metric is generated using a machine learning model trained on historical data.

6. The one or more computer storage media of claim 1, wherein the risk metric is scaled to a standardized range or transformed into a percentile.

7. A method for a user application performed by one or more processors, the method comprising:
receiving a request to authorize a user to use services provided by a first entity; retrieving a plurality of metrics associated with the user from a database;
generating a risk metric based on the plurality of metrics associated with the user, automatically determining, based on the risk metric, that the user is authorized to use the services of the first entity with a second entity assuming risk for the services provided by the first entity; and
communicating an authorization decision to a graphical user interface, indicating that the user is authorized to use the services of the first entity.

8. The method of claim 7, wherein the risk metric is based on a weighted evaluation of the plurality of metrics associated with the user.

9. The method of claim 7, wherein the second entity assuming risk for the services provided by the first entity is a merchant service.

10. The method of claim 7, wherein the plurality of metrics related to the first entity comprises credit score information.

11. The method of claim 7, wherein the second entity assumes the risk by guaranteeing a payment or assuming a liability for an authorized user.

12. The method of claim 7, wherein the authorization decision is determined based on predefined risk thresholds set by the second entity.

13. A system comprising:
a processor; and
one or more computer storage media storing computer-readable instructions thereon that, when executed by the at least one processor, cause the at least one processor to:
receive a request to authorize a user to use services provided by a first entity;
store a plurality of metrics associated with the user in a database;
retrieve the plurality of metrics from the database;
generate a risk metric based on the plurality of metrics associated with the user;
automatically determine, based on the risk metric, that the user is authorized to use the services of the first entity with a second entity assuming risk for the services provided by the first entity; and
communicate an authorization decision to a graphical user interface, indicating that the user is authorized to use the services of the first entity.

14. The system of claim 13, wherein the graphical user interface displays an authorization status indicator indicating a user's authorized access.

15. The system of claim 13, wherein the graphical user interface provides a user-friendly interface for accessing and utilizing the services of the first entity.

16. The system of claim 13, wherein the communication to the graphical user interface includes displaying one or more available services and one or more relevant terms or conditions.

17. The system of claim 13, further comprising monitoring an authorized user's usage of the services and adjusting the authorization decision based on their behavior and compliance with one or more service terms.

18. The system of claim 13, wherein the plurality of metrics associated with the user is periodically updated to ensure accuracy and relevancy of a risk assessment.

19. The system of claim 13, wherein the authorization decision is automatically reevaluated in response to changes in the plurality of metrics associated with the user or external factors affecting their creditworthiness.

20. The system of claim 13, wherein the risk metric is generated using statistical analysis techniques to identify patterns and correlations among the plurality of metrics associated with the user.
